(19) United States
(12) Patent Application Publication
(10) Pub. No.: US 2023/0149924 A1
(43) Pub. Date: May 18, 2023

(54) SYSTEM FOR PROVIDING FLUIDS IN MICROFLUIDIC PRODUCTS

(71) Applicant: STRATEC CONSUMABLES GMBH, Anif (AT)

(72) Inventors: Michael Schmid, Hallein (DE); Andrea Derflinger, Salzburg (AT); Thomas Umundum, Salzburg (AT)

(21) Appl. No.: 17/967,405

(22) Filed: Oct. 17, 2022

(30) Foreign Application Priority Data
Nov. 12, 2021 (LU) 102877

(51) Int. Cl. B01L 3/00

(52) U.S. Cl. CPC B01L 3/502723; B01L 3/502707; B01L 2200/0689; B01L 2300/044

(57) ABSTRACT

The invention relates to a method and a system for providing fluids, comprising two components, wherein a first component is a container with at least one first reservoir for taking up a fluid and a second reservoir for ventilation of the system, wherein said first and second reservoir are sealed with a seal, and a second component which is a dock for taking up the container, wherein the dock comprises an inner bottom surface comprising first formations for fluid piercing of the container's at least one first reservoir for taking up a fluid and second formations for piercing of the container's second reservoir for ventilation, and wherein said inner bottom surface is a drain plate comprising a drain, wherein the container has fins on its outer edge which engage into two parallel arranged recesses at the inner side surface of the dock for fixing the container within the dock in a first position when the fins of the container engage in a first recess which is a storage snap fit or a second position when the fins of the container engage in second recess at the inner side surface which is a retain snap fit.

### CROSS-REFERENCE TO RELATED APPLICATIONS

The present application claims priority to Luxembourg Patent Application No. LU 102877 filed on Nov. 12, 2021. The aforementioned application is hereby incorporated by reference in its entirety.

### BACKGROUND OF THE INVENTION

### Field of the Invention

The invention relates to a system and a method for providing fluids in microfluidic products.

### Brief Description of the Related Art

Microfluidic devices for use in clinical diagnostics and life sciences are produced by a number of companies. For example, STRATEC® Consumables GmbH, Anif, Austria, produces a number of devices for specimen handling and detection for use in automated analyser systems and other laboratory instrumentation.

Microfluidic devices are used for fluid manipulation at a small scale, typically characterised by fluid volumes measured in μL (microlitres). Fluids like liquids that will have to be handled in microfluidic devices are stored in containers. The container provide means for sealing for avoiding any loss of liquid which takes even more into account when working with volumes in a microliter range.

Container liquid storage in the prior art relate to single- or double-sided heat-sealed container which are sealed against the environment with separate O-rings. Such a container is usually formed of three to five parts. Published U.S. Patent application No. US 2016/0175842 A1 discloses a device for introducing a liquid sample into a microfluidic system which includes an adapter component that is configured to be fluidically coupled to the microfluidic system via at least one channel. The adapter component has a receiving section that is configured to guide and accommodate a sample container. The receiving section positions the sample container in a first predetermined receiving position via a boundary element after the sample container is introduced into the receiving section. Starting from the first predetermined receiving position, the sample container is conveyed to a second predetermined receiving position within the receiving section. In the second predetermined receiving position, an opening element arranged below the receiving section in the adapter component penetrates the sample container such that the liquid sample of the sample container is configured to be conveyed to the at least one channel.

In published U.S. Patent application No. US 2006/0183216 A1 a container for a liquid reagent is described, wherein the container has an outer wall and an internal piercing member, such that, upon application of pressure to the outer wall of the container, the internal piercing member punctures the container from the inside, thereby liberating the liquid contained therein. Such a container is configured to store the liquid for periods between 6 to 18 months with minimal loss of the liquid inside, other than if the container is ruptured. Such a container is also configured to require a particular force to be applied to the outer wall to cause the internal piercing member to puncture the container, such a force being greater than that ordinarily experienced by the container during routine storage, transport, or handling. The container is preferably adapted for use with a microfluidic cartridge.

Liquid handling system and methods for mixing and delivering liquid reagents are also disclosed in published U.S. Patent application No. US 2009/0246085 A1 relating to a liquid storage apparatus provides a safe and easy to use device for efficiently managing liquid reagents used in a variety of laboratory equipment. The liquid storage apparatus according to this document helps reduce the likelihood of accidents, allows for flexibility of experimental design, and helps maximize the use of chemical regents to prevent waste. The apparatus includes a plurality of containers with a pierceable septum interface at each end. The apparatus also includes a lower array of needles with each of the lower needles in the lower array of needles arranged to penetrate the bottom pierceable septum of a different one of the containers. The apparatus further includes a piercing device arranged to penetrate the top pierceable septum of a different one of the containers. Each of the piercing devices include a passageway so gas can flow into the pierced container.

Published U.S. Patent application No. US 2014/0161686 A1 discloses a system and method of dispensing liquids in a microfluidic device. The microfluidic system includes a droplet actuator having an interior cavity and a series of electrodes arranged along the interior cavity for forming a droplet-operation path there through. The droplet actuator has a module-engaging side including an opening that is in flow communication with the interior cavity. The microfluidic system also includes a reservoir module configured to be coupled to the droplet actuator. The reservoir module includes a plurality of liquid compartments having respective outlets and at least one seal positioned along the outlets to retain liquid within the liquid compartments. The reservoir module is movable along the module-engaging side of the droplet actuator to position the outlets relative to the opening. The microfluidic system also includes a piercer having a tip configured to penetrate the seal thereby permitting the liquid within the corresponding liquid compartment to flow into the opening.

A liquid reservoir connector is further described in published U.S. Patent application No. US 2006/0002827 A1. The device and method according to this document are intended for interconnecting at least one reservoir for holding at least one liquid with at least one area in or on a test element to be supplied and/or brought into contact with the liquid is provided. In accordance with one embodiment, the reservoir and the area to be supplied and/or brought into contact with the liquid are integrated on the same test element or are arranged on separate embodiments. The device comprises at least one capillary-like tube or conduit comprising an inlet and an outlet at opposite ends thereof, which tube or conduit is at least along a section at least nearly rigid.

Published U.S. patent application US 2007/048194 A1 relates to the use of a disposable container comprising a cylinder containing a plunger that is displaceable guided in said cylinder and a connection that is provided on a first end of the cylinder lying opposite the plunger, said container being designed to create a difference in pressure in a microfluidic device to hold an agent for processing molecules and/or to act as a reaction vessel.

Published Japanese patent JP 4 883188 B2 discloses a reactor which comprises a closed reaction chamber for allowing a sample to react, reaction channels connected to the reaction chamber, a sample container having a sample-containing section in which the sample can be contained, a sample channel that is connected to the sample-containing section in using the sample container, a syringe for feeding a liquid, and a switching valve for connecting the syringe to the reaction channel or the sample channel.

Disadvantages of common systems are that they are typically complicated to manufacture, consist of three or more individual components, the sealing of the fluid during transport and storage is not guaranteed or requires several septa. For assembly, especially semi- or fully-automated assembly, the problem is compounded by the fact that some components can be very small or non-rigid. This increases the cost factor and thus the applicability. Many designs typically also require a venting or double heat seal to avoid residual fluids in the reservoir.

Thus, the disadvantages of known system can be summarized to be related to a high number of required parts, a difficult assembly of typically three or more potentially very small and non-rigid parts, the possible use of siphon for venting or double heat sealing and a friction dependent storage position.

There is a need for an easily to assemble and manufacture storage for fluids like liquids allowing a released.

### SUMMARY OF THE INVENTION

### Summary of the Invention

It is therefore the object of this invention to provide a device for storing fluids like liquids that is easily manufactured and assembled. The present invention provides a system for providing fluids, comprising two components, wherein
a first component is a container with at least one first reservoir for taking up a fluid and a second reservoir for ventilation of the system, wherein said first and second reservoir are sealed with a seal, and
a second component which is a dock for taking up the container, wherein the dock comprises an inner bottom surface comprising first formations for fluid piercing of the container's at least one first reservoir for taking up a fluid and second formations for piercing of the container's second reservoir for ventilation, and wherein said inner bottom surface is a drain plate comprising a drain,
   wherein the container has fins on its outer edge which engage into two parallel arranged recesses at the inner side surface of the dock for fixing the container within the dock in a first position when the fins of the container engage in a first recess which is a storage snap fit or a second position when the fins of the container engage in second recess at the inner side surface which is a retain snap fit.

In a further aspect of the invention, first and second reservoir are sealed with a single seal.

It is further intended that the seal is a foil.

In a further embodiment of a system according to the invention, the second reservoir is centrally arranged and surrounded by the at least one first reservoir.

It is envisaged that the inner bottom surface of the container is a drain plate comprising a drain.

In a further aspect of a system according to the invention, the fins of the container are angled towards the upper side of the container.

In another embodiment of the container, the second reservoir is a centrally in the inner volume of the container arranged duct.

The fins can be made of an elastic material so that they may move into a first recess of the dock and a second recess without breaking.

The container may have a cylindrical shape.

It another embodiment, the fins of the container are arranged directly next to another so that the container is surrounded by a ring formed by the fins.

It is further envisaged that a container of a system according to the invention may comprise further reservoirs for fluids.

It is intended that a container may comprise formations for fluid piercing with different heights for a fluid release depending from the position of the container in the dock.

The system may also comprise in another embodiment a container, wherein each reservoir has a separate seal.

Another object of the present disclosure is a method for providing a fluid by a system comprising a container and a dock, comprising the steps of
providing at least a first fluid in a first reservoir of the container comprising at least one first reservoir for taking up the fluid and a second reservoir for ventilation of the system, wherein said first and second reservoir are sealed with a seal;
inserting the container into the dock, wherein fins on the outer surface of the container engage in a first recess at the inner side surface of the dock to fix the container in a storage snap fit;
pressing the container further towards an inner bottom surface of the dock, wherein the fins of the container move into a second recess at the inner side surface of the dock to fix the container in a retain snap fit,
piercing the seal of the at least one first reservoir by piercing formations arranged at the inner bottom surface of the dock;
piercing the seal of the second reservoir by piercing formations arranged at the inner bottom surface of the dock for ventilation of the system;
releasing the fluid into a drain arranged at the inner bottom surface of the dock which is a drain plate.

The method may further comprise the use of at least a second reservoir that is arranged in the container and pierced for pressurization of the container and releasing the liquid into the drain arranged in the drain plate.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### BRIEF DESCRIPTION OF THE FIGURES

The invention will be described based on figures. It will be understood that the embodiments and aspects of the invention described in the figures are only examples and do not limit the protective scope of the claims in any way. The invention is defined by the claims and their equivalents. It will be understood that features of one aspect or embodiment of the invention can be combined with a feature of a different aspect or aspects of other embodiments of the invention, in which:

FIG. 1 shows an empty fluid container with bottom side up.

FIG. 2 shows a fluid container with bottom side up filled with a fluid.

FIG. 3 shows a filled fluid container with bottom side up, wherein the bottom side is closed with a seal.

FIG. 4 shows a sealed container which is inserted into a dock.

FIG. 5 shows a sectional view of a container and dock with the container located above the dock.

FIG. 6 shows the container placed in the dock in a first position.

FIG. 7 shows the container in the dock in a second position with the septum being opened for releasing the fluid.

FIG. 8 shows a container with a ring surrounding the container.

FIG. 9 shows an alternative arrangement of a seals on different level for first and second reservoir.

FIG. 10 shows an embodiment with a drain located on one side of the drain plate.

FIG. 11 shows a container with more than two reservoirs.

FIG. 12 shows a multistage release embodiment.

### DETAILED DESCRIPTION OF THE INVENTION

The technical problem is solved by the independent claims. The dependent claims cover further specific embodiments of the invention.

The present disclosure relates to the storage of fluids in container like a cartridge comprising two easily to manufacture components allowing a controlled release of the content for analysis purposes for instance.

A fluid within the meaning of the present disclosure shall designate a liquid, gas, solid, mixture thereof, or any other material that flows under external force or shear stress. A seal is within the meaning of the present disclosure means any material that is appropriate for closing the open side of a container and allows to be opened by piercing with a suitable formation like a sharp edge or a needle-like device like a pin.

A seal within the meaning of the present invention is a foil or may be made of any other material that can be applied to the surrounding walls of an opening of a reservoir for closing it. The seal may be fixed by heat or gluing. In essence, any material that is suitable for being fixed to a reservoirs lower end for closing it is suitable as a seal as long as it can be pierced by a rigid formation like a mandrel or spike to open it.

The invention relates to a system comprising two components, wherein a first component is the container and the second component the dock. The container has at least one first reservoir for fluids and a second reservoir for ventilation of the system. It is obvious for a skilled person that the container may comprise more than one reservoir for receiving fluids so that such fluids can be stored separately from another. By means of a snap lock, the container can be fixed in the dock in a first position for transportation and storage. By applying pressure, the container can be pushed deeper into the dock in a second position, so that needle-like devices will pierce the seal of the container, and the fluid exits through the opened seal in a controlled manner through an opening of the dock.

The present disclosure relates to a two-part system which is thus easy and cheap to manufacture. The container is manufactured by basic mold design avoiding actuated components for obtaining an easy assembly—design for automation. No extra siphon or valve for venting are required for a two-step mechanical actuation- and liquid storage and release.

The container comprises as already mentioned two reservoirs, which are sealed by a seal like a septum, and a dock that only allows unidirectional movement and optionally rotation of the container when inserted onto the dock. One of the container's reservoirs, also called the ventilation duct, is provided with a hole. Its counterpart, the dock's inner bottom surface, comprises formations for opening the seal by piercing it and a tapered ring located at the bottom surface of the dock allowing to connect the container tightly and sealed to the dock.

The arrangement of the two reservoirs in the container differs from the system as shown in published Japanese patent JP 4 883188 B2 with one reservoir for the fluid arranged in the container and the reservoir for ventilation arranged in the dock. JP 4 883188 B2 is silent about arranging both reservoirs in the container. The related technical effect is that the container is responsible for the provision of fluids and the ventilation. The dock is thus less complex regarding its structure which is advantageous. The arrangement of both reservoirs, for receiving fluids and for ventilation, results in a structure of the container which also allows an easy manufacture of the container so that the present invention provides advantages regarding both parts of the system.

The container can be connected to the dock in two steps. In the first step, it is connected to the dock, but the seal is not opened. This can be achieved, among other things, by means of fins on the container and a suitable snap lock in the dock like a circular recess in the dock's inner side surface for taking up the upwardly angled fins of the container. At this stage, in the so called first position, the container is safely connected to the dock and thus ready for transport and storage while keeping the fluid in its first reservoir. In the so called second position, initiated for example by pressing the container in a second snap closure in the dock, the seal of the container is pierced by formations arranged on the inner bottom surface of the dock in such a way that at least one of the reservoirs in the container is no longer sealed and the fluid for instance can leak out.

In addition, it is also conceivable to add a further transport safety device which prevents the container from being inadvertently pushed into the second position. The ventilation reservoir can be used to ensure and/or force a controlled leakage of the fluid (e.g., by applying an overpressure). Container and dock can be manufactured rotationally symmetric.

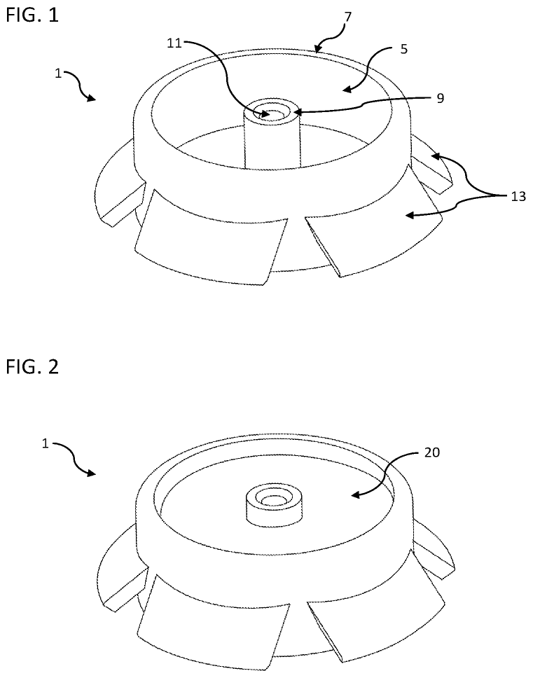

FIG. 1 shows an empty container 1 with bottom side up. The container 1 has a cylindrical form with a first reservoir 5 for taking up a fluid between an outer edge 7 of the cavity and an inner edge 9 of the first reservoir 5. The inner part of container 1 comprises the second reservoir 11, which is a ventilation duct.

The outer edge 7 of the first reservoir 5 comprises protrusions in form of fins 13 which are angled towards the upper side of the container 1. The number of fins 13 is adjusted to the outer circumference of container 1 as the fins will have to be a kind of elastic for fitting in the first or second position of the dock, respectively. It is also within the scope of the present disclosure that the fins are formed as an angled ring surrounding the outer edge 7 of the container 1.

FIG. 2 shows the container 1 with bottom side up filled with a fluid 20.

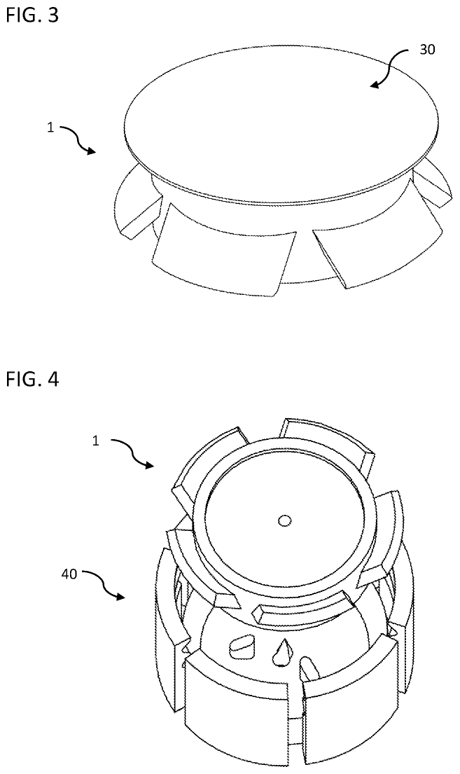

FIG. 3 shows the container 1 with bottom side up filled with a fluid 20 which is sealed to prevent leakage of the fluid 20 with seal 30. Seal 30 seals the first reservoir 5 and the second reservoir 11 and can be a foil. Seal 30 can be applied by heat sealing or gluing.

FIG. 4 shows a sealed container 1 which located above a dock 40.

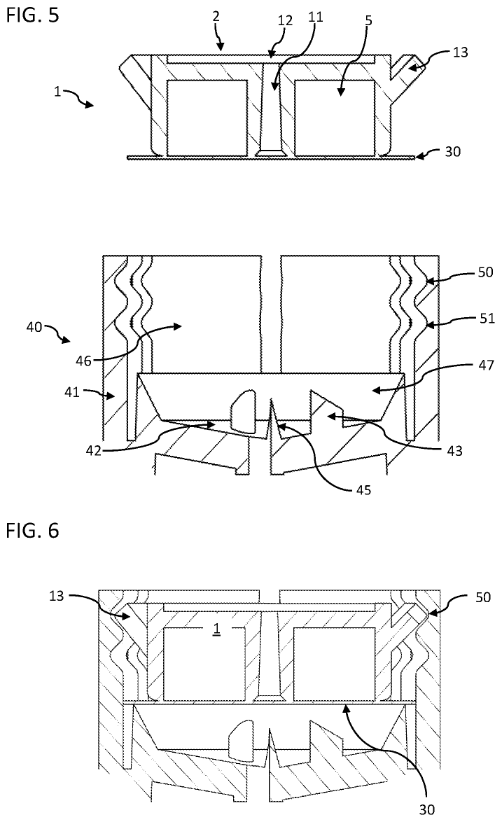

FIG. 5 shows a sectional view of the perspective view shown in FIG. 4. The upper side 2 of container 1 is shown with an opening 12 of the second reservoir 11. In the shown embodiment, fins 13 surround the cylindrical body of container 1. The bottom side of container 1 is sealed with seal 30.

Dock 40 has outer walls 41 which are adapted to the geometrical form of container 1 for surrounding the container 1 when entering the inner volume of dock 40. The bottom surface 42 of dock 40 comprises formations for fluid piercing 43 of the seal 30 and a centrally arranged formation for air piercing 45. The transition area from the dock's bottom surface 42 to the inner side surface 46 of the dock's outer walls 41 comprises a sealing lip 47.

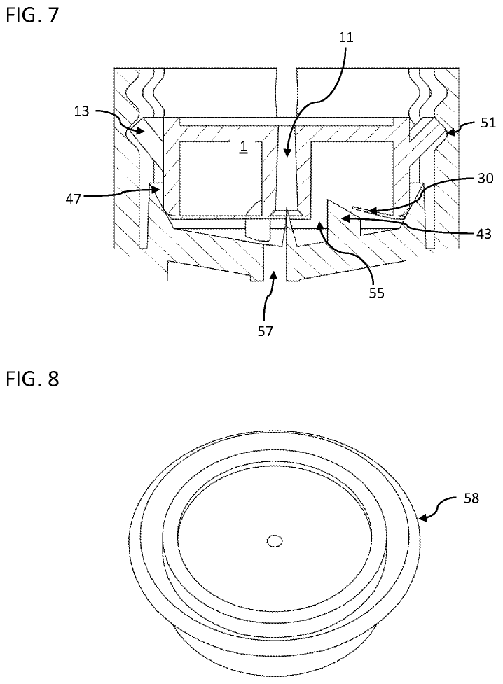

The upper part of the inner side surface 46 of the dock's outer walls 41 comprises two circular recesses, wherein the upper recess represents a storage snap fit 50 into which fins 13 will engage for keeping a container one in a first position without opening seal 30 (comp. FIG. 6). By moving or pressing the container 1 further towards bottom surface 42 of dock 40, fins 13 will engage into a retain snap fit 51 and the formations for liquid piercing 43 will pierce seal 30 and thus open the first reservoir 5. The formations for air piercing 45 will pierce seal 30 for opening the second reservoir 11 (comp. FIG. 7).

The first position can also be designated as a storage position (FIG. 6).

The second position which is shown in FIG. 7 can also be designated as a draining position. When the container 1 is pushed down onto the sealing lip 47 an airtight fit is established. The container 1 locks with its fins 13 into the retain snap-fit 51 to form a permanent and safe press-fit. While moving container 1 downwards from the first position into the second position, seal 30 of container 1 is pierced to release the fluid into the fluid outlet 55. Moving the container 1 further towards into the retaining position will cause the second reservoir 11 in the middle to be pierced enabling a pressurization of container 1 and to release the liquid out through the drain 57. The empty container remains in the retain position.

FIG. 8 shows a container that has a surrounding ring 58 instead of the so far described fins.

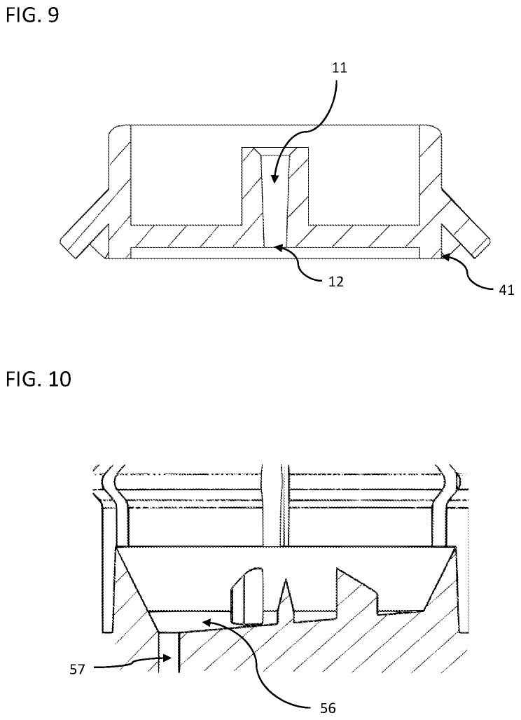

FIG. 9 shows a sectional view through a container, wherein the lower end of outer wall 41 and the lower end of opening 12 of the second reservoir 11 are not on the same level so that two independent seals are used.

FIG. 10 shows an embodiment with a drain 57 located on one side of the drain plate 56. The drain may be located anywhere in the drain plate.

FIG. 11 shows a container providing a first reservoir 5, a second reservoir 11 and a third reservoir 14. It is obvious that further reservoirs may be added.

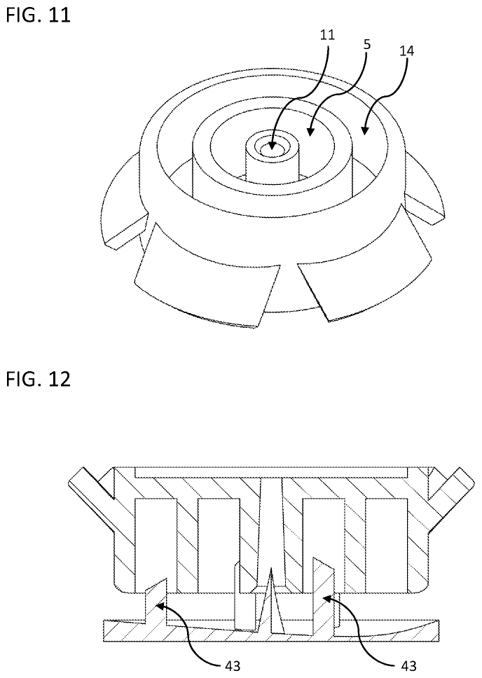

FIG. 12 shows a multistage release embodiment providing formations for fluid piercing 43 with differing heights so that the respective reservoirs will be pierced at different positions of the container in the dock.

The advantages of the invention can be summarized as follows:
Simple, cheap, and easy to automate container and dock design avoiding undercuts or special geometries that need special tooling in the design.
Single sided heat sealing with air venting and liquid release on the same side.
Allowing individual equipped cartridges so that the fluid in the container is independent from cartridge.
Fragile heat-sealing foil is protected so that the design allows the foil to be within or integrated into the assembly.
Cartridge activation easy to automate due to only one linear motion axis needed for activation.
Safe retain position leaving a very small opening for leakage or contamination after usage.
Removal of liquid container is impossible without destroying the cartridge due to the circular snap fit.
Ready to use, without further assembly so that the fluid can be transported and stored together in the individual cartridge.

Alternative approaches may encompass:
A design with fins is not necessarily required. It can also be a circumferential non-sprung ring. Spring action on the container is not compulsory (comp. FIG. 8).
Other fixation options (haptic, magnetic) are also conceivable which may be used to allow a two- or multi-stage fixation.
Multiple use of the dock is conceivable if the container can be removed. Such an embodiment is useful if several fluids have to be supplied serially via one access point.
An outer sealing edge and air siphon in the middle of the device do not necessarily have to be on the same level (comp. FIG. 9).
The drain can be moved anywhere in the drain plate (comp. FIG. 10).
All polymers with a minimum of flexibility and sealability (welding or gluing) are suitable as material for the septum, depending on the fluid and material of the container.
Coated (metal, SiOₓ, fluorine etc.) septa are also possible depending on properties of the stored fluid or the respective application.
The container may also be made of glass or metal.
Alternatively, a container may comprise more than two reservoirs, e.g., for separate storage of several fluids and mixing directly on the microfluidic device (comp. FIG. 11).
A multi-stage release is conceivable which can be achieved through different piercing levels of septa sealing different fluids (comp. FIG. 12).

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMERALS

1 container
2 upper side
5 first reservoir
7 outer edge
9 inner edge
11 second reservoir
12 opening
13 fin
14 third reservoir
20 fluid
30 seal
40 dock
41 outer wall
42 bottom surface
43 formation for fluid piercing
45 formation for air piercing
46 inner side surface
47 sealing lip
50 storage snap fit
51 retain snap fit
55 fluid outlet
56 drain plate
57 drain
58 ring

What is claimed is:

1. A system for providing fluids, comprising two components, wherein
a first component is a container with at least one first reservoir for taking up a fluid and a second reservoir for ventilation of the system, wherein said first and second reservoir are sealed with a seal, and
a second component which is a dock for taking up the container, wherein the dock comprises an inner bottom surface comprising first formations for fluid piercing of the container's at least one first reservoir for taking up a fluid and second formations for piercing of the container's second reservoir for ventilation, and wherein said inner bottom surface is a drain plate comprising a drain,
wherein the container has fins on its outer edge which engage into two parallel arranged recesses at the inner side surface of the dock for fixing the container within the dock in a first position when the fins of the container engage in a first recess which is a storage snap fit or a second position when the fins of the container engage in second recess at the inner side surface which is a retain snap fit.

2. The system of claim 1, wherein first and second reservoir are sealed with a single seal.

3. The system of claim 1, wherein the seal is a foil.

4. The system of claim 1, wherein the second reservoir is centrally arranged and surrounded by the at least one first reservoir.

5. The system of claim 1, wherein the inner bottom surface of the container is a drain plate comprising a drain.

6. The system of claim 1, wherein the fins of the container are angled towards the upper side of the container.

7. The system of claim 1, wherein the second reservoir is a centrally in the inner volume of the container arranged duct.

8. The system of claim 1, wherein the fins are made of an elastic material.

9. The system of claim 1, wherein the container has a cylindrical shape.

10. The system of claim 1, wherein the fins of the container are arranged directly next to another so that the container is surrounded by a ring formed by the fins.

11. The system of claim 1, comprising further reservoirs for fluids.

12. The system of claim 1, comprising formations for fluid piercing with different heights for a fluid release depending from the position of the container in the dock.

13. The system of claim 1, wherein each reservoir has a separate seal.

14. A method for providing a fluid by a system comprising a container and a dock, comprising the steps of
providing at least a first fluid in a first reservoir of the container comprising at least a first reservoir for taking up the fluid and at least a second reservoir for ventilation of the system, wherein said first and second reservoir are sealed with a seal;
inserting the container into the dock, wherein fins on the outer surface of the container engage in a first recess at the inner side surface of the dock to fix the container in a storage snap fit;
pressing the container further towards an inner bottom surface of the dock, wherein the fins of the container move into a second recess at the inner side surface of the dock to fix the container in a retain snap fit,
piercing the seal of the at least first reservoir by piercing formations arranged at the inner bottom surface of the dock;
piercing the seal of the at least second reservoir by piercing formations arranged at the inner bottom surface of the dock for ventilation of the system;
releasing the fluid into a drain arranged at the inner bottom surface of the dock which is a drain plate.

15. The method of claim 14, wherein at least a second reservoir is arranged in the container that is pierced for pressurization of the container and releasing the liquid into the drain arranged in the drain plate.
